(19) United States
(12) Patent Application Publication
(10) Pub. No.: US 2013/0121524 A1
(43) Pub. Date: May 16, 2013

(54) HEADSET STRUCTURE

(71) Applicant: Min-ta LIAO, New Taipei (TW)

(72) Inventor: Min-ta LIAO, New Taipei (TW)

(73) Assignee: Cheng Uei Presision Industry Co., Ltd., New Taipei City (TW)

(21) Appl. No.: 13/294,118

(22) Filed: Nov. 10, 2011

(51) Int. Cl. H04R 1/10

(52) U.S. Cl. 381/375

(57) ABSTRACT

A headset structure is disclosed. The headset structure includes a microphone boom and an earphone housing. An elastic positioning structure is formed on an outer surface of the microphone boom, and the earphone housing has a gear-shaped notch adjusting structure for matching with the elastic positioning structure. In the present invention, the length of the microphone boom can be adjusted to be lengthened or shortened as required by the elastic positioning structure of the microphone boom and the gear-shaped notch adjusting structure of the earphone housing.

### BACKGROUND OF THE INVENTION

1. Field of the Invention

The present invention generally relates to a gear-shaped notch adjusting structure, and more particularly to a gear-shaped notch adjusting structure for a microphone boom of a headset.

2. Description of Prior Art

Currently, a headset which is integrated by a microphone and an earphone has become a commonly used device. A conventional headset comprises a headband, an earphone unit, and a microphone unit. The microphone unit is rotatable or bendable relative to the headband. When a user utilizes the headset, the microphone unit is rotated to front of the user's face, so that the microphone unit is positioned near the user's mouth and the user's voices can be inputted to the microphone unit. When the user stops utilizing the headset, the microphone unit is rotated above the user's head so that the microphone unit is superposed on the headband. Disadvantages of the conventional headset are that a complicated rotation structure is required and a microphone boom of the headset fails to be adjusted as required. In addition, the microphone unit looses or drops easily because components of the headset suffer wear and tear when the headset is used for a period of time.

An adjustable mechanism is added to the microphone unit by manufactures, so as to adjust a length and a position of the microphone unit as required. China Utility Patent 200820094336.9 discloses an ear microphone, comprising an ear hanger part, a leader, a leader holding device, and a leader adjusting device. The leader adjusting device is arranged in the leader holding device. The leader adjusting device includes a fixed block, a pressure block, a button, and a plurality of elastics. The fixed block comprises a soleplate which is provided with a button through hole. Two ends of the soleplate are respectively provided with a side plate that is protuberant upwards and provided with a penetration hole. The upper end of the button penetrates through the button through hole and is connected with the pressure block. The button comprises a rod body. The top end of the rod body is provided with a through hole and a penetration hole, while the bottom end thereof is protuberantly provided with a bead. One of the elastics is installed and pressed between the bead and the bottom surface of the soleplate of the fixed block, while the other elastics are installed and pressed between the upper wall surface of a pressure block holding groove of the leader holding device and the pressure block. The leader, which is inserted into the two penetration holes of the fixed block and the penetration hole of the rod body, is arranged in the leader holding groove. Preferredly, the elastics are springs. The adjusting mechanism of the ear microphone adjusts the length of the ear microphone by using the fixed block, the pressure block, the button, and the springs. However, the button is an unnecessary element, and thus the adjusting processes of the ear microphone are too complicated.

### SUMMARY OF THE INVENTION

To solve the above-mentioned deficiencies in the prior arts, an objective of the present invention is to provide a headset structure. When the headset structure is used, a microphone boom of the headset can be adjusted as required. When the headset structure is not used, the microphone boom of the headset structure can be received in an earphone housing.

To implement the above-mentioned objective, the headset structure in accordance with an aspect of the present invention comprises a microphone boom and an earphone housing. An elastic positioning structure is formed on an outer surface of the microphone boom, and the earphone housing has a gear-shaped notch adjusting structure for matching with the elastic positioning structure.

Preferredly, the microphone boom comprises a microphone boom housing top cover, a microphone boom housing bottom cover, and a microphone element, and the elastic positioning structure is formed on one of the microphone boom housing top cover and the microphone boom housing bottom cover.

Preferredly, the elastic positioning structure comprises an elastic arm and a protruding arc-shaped structure.

Preferredly, an auxiliary rib is formed on each of the microphone boom housing top cover and the microphone boom housing bottom cover, and each auxiliary rib is perpendicular to an extending axis direction of the microphone boom.

Preferredly, the earphone housing comprises an earphone housing top cover and an earphone housing bottom cover, at least one earphone rib is formed inside each of the earphone housing top cover and the earphone housing bottom cover, and each earphone rib is parallel to the extending axis direction of the microphone boom.

Preferredly, at least one of the earphone ribs of the earphone housing top cover and the earphone housing bottom cover has the gear-shaped notch adjusting structure for matching with the elastic positioning structure.

Preferredly, the gear-shaped notch adjusting structure comprises a plurality of adjacent arc-shaped surfaces for matching with the protruding arc-shaped structure of the elastic positioning structure.

The present invention is capable of adjusting the length of the microphone boom by utilizing the elastic positioning structure and the gear-shaped notch adjusting structure which are easily assembled. Furthermore, the auxiliary ribs of the microphone boom housing top and bottom covers and the earphone ribs of the earphone housing top and bottom covers are perpendicular and function to support the microphone boom stably. Accordingly, the adjusting processes of the microphone boom are more stable, and lifespan of the headset structure is increased. When the headset is not used, the microphone boom can be received in the earphone housing.

### BRIEF DESCRIPTION OF THE DRAWINGS

FIG. 1 is a perspective view of a headset structure in accordance with an embodiment of the present invention.

FIG. 2 is a side view of the headset structure in accordance with the embodiment in FIG. 1 of the present invention.

FIG. 3 is a component exploded view of the headset structure in accordance with the embodiment in FIG. 1 of the present invention.

FIG. 4 is a schematic diagram showing an elastic positioning structure and auxiliary ribs of a microphone boom in accordance with the embodiment in FIG. 1 of the present invention.

FIG. 5 is a sectional view showing a combination of the elastic positioning structure and a gear-shaped notch adjusting structure in accordance with the embodiment in FIG. 1 of the present invention.

FIG. 6 is a schematic diagram showing that the microphone boom is adjusted to be lengthened or shortened.

### DETAILED DESCRIPTION OF THE INVENTION

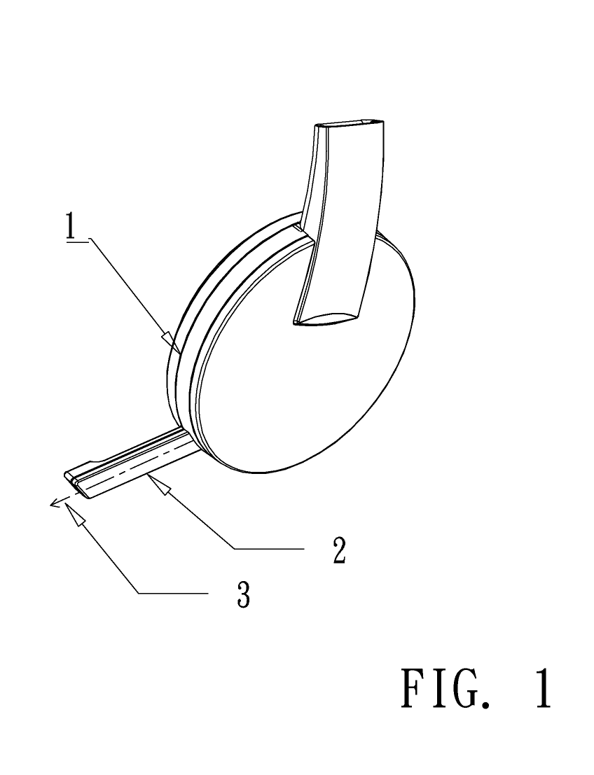

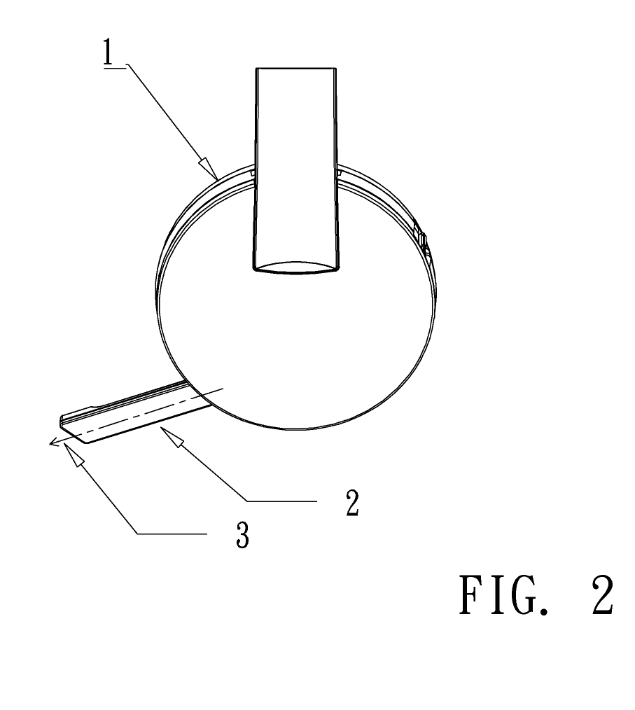

Please refer to FIGS. 1-3, a headset in accordance with a first embodiment of the present invention comprises an earphone housing 1 and a microphone boom 2. The microphone boom 2 can be lengthened and shortened along an extending axis direction 3 of the microphone boom 2. The microphone boom 2 comprises a microphone boom housing top cover 21, a microphone boom housing bottom cover 22, and a microphone element 5 positioned between the microphone boom housing top cover 21 and the microphone boom housing bottom cover 22. The earphone housing 1 comprises an earphone housing top cover 11, an earphone bottom cover 12, and other corresponding elements.

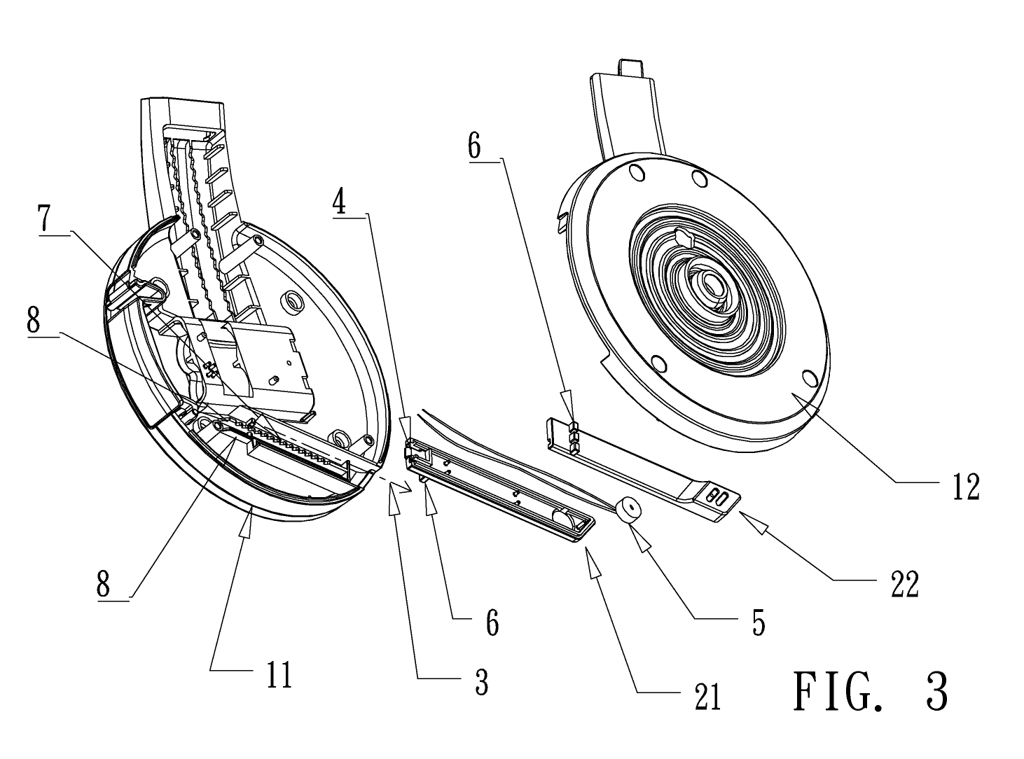

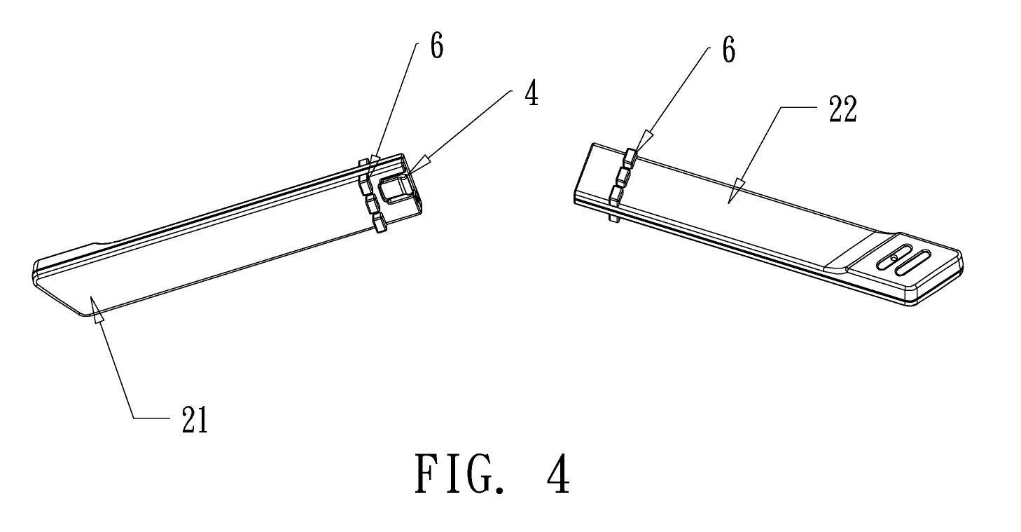

Please refer to FIGS. 3-4, an auxiliary rib 6 is formed on an outer surface of each of the microphone boom housing top and bottom covers 21, 22. Each auxiliary rib 6 is perpendicular to the extending axis direction 3 of the microphone boom 2. Preferredly, the two auxiliary ribs 6 are symmetrically disposed on the outer surfaces of the microphone boom housing top and bottom covers 21, 22. Each of the microphone boom housing top and bottom covers 21, 22 has at least one or more sets of the ribs 6. The shape of each of the ribs 6 can be changed with the appearance of the microphone boom 2. For example, each of the ribs 6 can be strip-shaped or piece-shaped.

At least one earphone rib 8 is formed inside each of the earphone housing top and bottom covers 11, 12. Each of the earphone ribs 8 is parallel to the extending axis direction 3 of the microphone boom 2. Each of the earphone housing top and bottom covers 11, 12 has at least one earphone rib 8 for supporting the microphone boom 2. The shape of each of the ribs 6 can be changed with the appearance of the microphone boom 2. Furthermore, a plurality of earphone ribs 8 can be used so that the microphone boom 2 moves stably.

The auxiliary ribs 6 of the microphone boom housing top and bottom covers 21, 22 are perpendicular to the earphone ribs 8 of the earphone housing top and bottom covers 11, 12. A space for each of the earphone ribs 8 to pass is formed in a position between each of the auxiliary ribs 6 and each corresponding earphone rib 8. Each of the auxiliary ribs 6 and each corresponding earphone rib 8 lead the microphone boom 2 to be lengthened and shortened along the extending axis direction 3 of the microphone boom 2. Furthermore, the auxiliary ribs 6 of the microphone boom housing top and bottom covers 21, 22 and the earphone ribs 8 of the earphone housing top and bottom covers 11, 12 function to support the microphone boom 2 stably.

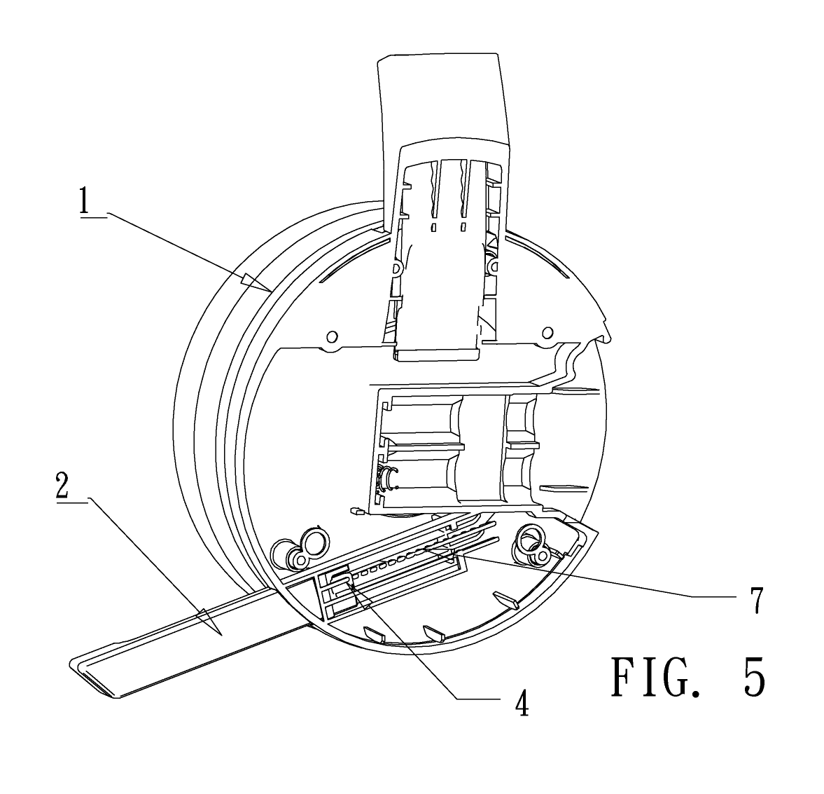

Moreover, an elastic positioning structure 4 is formed on at least one of the microphone boom housing top and bottom covers 21, 22. As shown in FIG. 4, the elastic positioning structure 4 comprises an elastic arm and an arc-shaped structure. The appearance of the elastic positioning structure 4 can be changed with the appearance of the microphone boom 2. When an external force is applied to the elastic positioning structure 4, the elastic structure 4 is compressed and the appearance of the elastic structure 4 is changed. The friction between the microphone boom 2 and the earphone housing 1 is decreased so that the microphone boom 2 moves correspondingly to the earphone housing 1. Furthermore, each of the earphone ribs 8 inside the earphone housing 1 comprises a gear-shaped notch adjusting structure 7 for matching with the elastic positioning structure 4. In one embodiment of the present invention, the appearance of the elastic positioning structure 4 of the microphone boom 2 is a protruding arc-shaped structure. As shown in FIG. 5, the gear-shaped notch adjusting structure 7 comprises a plurality of adjacent arc-shaped surfaces for matching with the elastic positioning structure 4. When the external force is applied to the elastic positioning structure 4, the elastic positioning structure 4 moves from one adjacent arc-shaped surface to a next adjacent arc-shaped surface or next adjacent arc-shaped surfaces. When the external force is removed, the elastic positioning structure 4 is fixed to the gear-shaped notch adjusting structure 7, so that the elastic positioning structure 4 does not move for implementing the positioning objective of the elastic positioning structure 4. When another external force is applied again, the microphone boom 2 can move again.

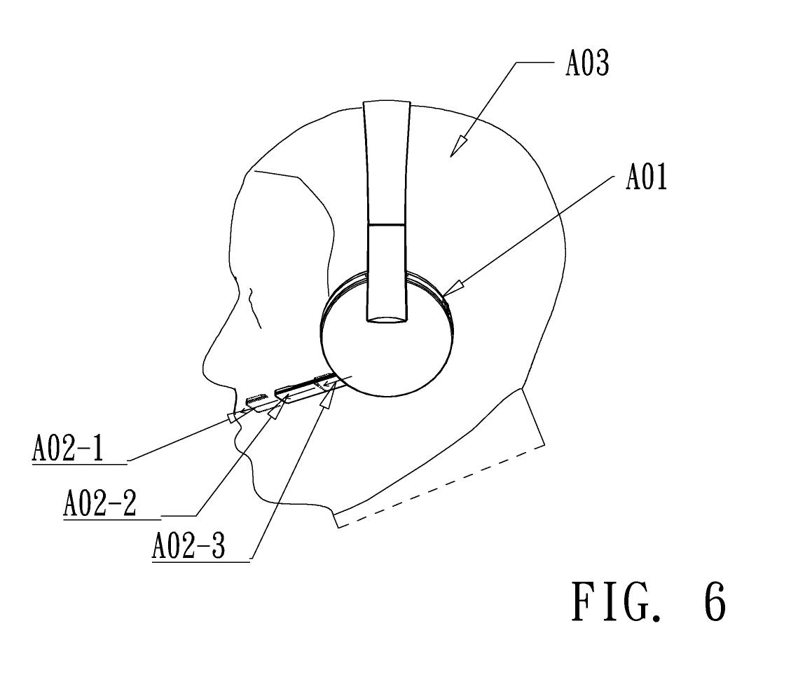

When the headset is utilized, the length of the microphone boom 2 can be adjusted to a suitable position as required by the elastic positioning structure 4 together with the gear-shaped notch adjusting structure 7. As shown in FIG. 6, when the length of the microphone boom 2 is adjusted, an exposure portion of the microphone boom 2 can be lengthened along the extending axis direction 3 of the microphone boom 2 according to a habit of a user A03. The microphone boom 2 can be adjusted to a suitable position A02-2 between a shortest position A02-3 of the microphone boom 2 and a longest position A02-1 of the microphone position 2. The design of the gear-shaped notch adjusting structure 7 can adjust the microphone boom 2 accurately and improve the problem that the microphone boom 2 suffers wear and tear when the headset is used for a period of time. Furthermore, the microphone boom 2 can be received in the shortest position A02-3 when the user A03 does not utilize the microphone element 5.

To extend lifespan of the microphone boom 2 of the headset, a lubricant component or medium can be applied between the gear-shaped notch adjusting structure 7 inside the earphone housing 1 and the elastic positioning structure 4 of the microphone boom 2 for decreasing the friction.

The above-mentioned embodiment discloses a detailed description of best implementation, but the above-mentioned embodiment does not limit the present invention. For example, the shapes and the numbers of the elastic positioning structure 4 and the auxiliary ribs 6 can be adjusted according to the length of the microphone boom 2. This adjusting design is conventional for one skilled in the same art of the present invention and omitted herein.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A headset structure, comprising a microphone boom and an earphone housing, wherein an elastic positioning structure is formed on an outer surface of the microphone boom, and the earphone housing has a gear-shaped notch adjusting structure for matching with the elastic positioning structure.

2. The headset structure as claimed in claim 1, wherein the microphone boom comprises a microphone boom housing top cover, a microphone boom housing bottom cover, and a microphone element, and the elastic positioning structure is formed on one of the microphone boom housing top cover and the microphone boom housing bottom cover.

3. The headset structure as claimed in claim 2, wherein the elastic positioning structure comprises an elastic arm and a protruding arc-shaped structure.

4. The headset structure as claimed in claim 2, wherein an auxiliary rib is formed on each of the microphone boom housing top cover and the microphone boom housing bottom cover, and each auxiliary rib is perpendicular to an extending axis direction of the microphone boom.

5. The headset structure as claimed in claim 1, wherein the earphone housing comprises an earphone housing top cover and an earphone housing bottom cover, at least one earphone rib is formed inside each of the earphone housing top cover and the earphone housing bottom cover, and each earphone rib is parallel to the extending axis direction of the microphone boom.

6. The headset structure as claimed in claim 5, wherein at least one of the earphone ribs of the earphone housing top cover and the earphone housing bottom cover has the gear-shaped notch adjusting structure for matching with the elastic positioning structure.

7. The headset structure as claimed in claim 3, wherein the gear-shaped notch adjusting structure comprises a plurality of adjacent arc-shaped surfaces for matching with the protruding arc-shaped structure of the elastic positioning structure.

8. The headset structure as claimed in claim 6, wherein the gear-shaped notch adjusting structure comprises a plurality of adjacent arc-shaped surfaces for matching with a protruding arc-shaped structure of the elastic positioning structure.
